(19) United States
(12) Patent Application Publication
(10) Pub. No.: US 2011/0163871 A1
(43) Pub. Date: Jul. 7, 2011

(54) RFID MONITORING OF DRUG REGIMEN COMPLIANCE

(76) Inventors: Shmuel Einav, Port JeffersonStation, NY (US); Sharma Satya, Setauket, NY (US); Milutin Stanacevic, Forest Hills, NY (US); Richard N. Fine, Stony Brook, NY (US)

(21) Appl. No.: 12/936,098

(22) PCT Filed: Apr. 1, 2009
(86) PCT No.: PCT/US09/39179

§ 371 Date: Mar. 21, 2011

Related U.S. Application Data
(60) Provisional application No. 61/041,349, filed on Apr. 1, 2008.
(60) Provisional application No. 61/162,704, filed on Mar. 24, 2009.
(60) Provisional application No. 61/049,824, filed on May 2, 2008.

(51) Int. Cl. G08B 1/08

(52) U.S. Cl. 340/539.11

(57) ABSTRACT

Disclosed is an apparatus and system for monitoring drug regimen compliance, the system utilizing a Radio Frequency Identification (RfID) tag affixed to a pharmaceutical agent and a wearable RFID reader that identifies a patient. The RFID tag identifies the pharmaceutical agent and the RFID reader wirelessly communicates with a central monitoring system upon ingestion of the pharmaceutical agent.

### PRIORITY

This application claims priority to U.S. Provisional Application No. 61/041,349, filed Apr. 1, 2008, and to U.S. Provisional Application No. 61/162,704, filed Mar. 24, 2009, the contents of each of which is incorporated herein by reference.

### FIELD OF THE INVENTION

The present invention relates generally to electromagnetic tag technology and, more specifically, to the use of Radio Frequency Identification (RFID) tags to ensure and track proper drug regimen compliance and oral medication.

### BACKGROUND OF THE INVENTION

In conventional hospital and long-term care settings, caregivers must manually supervise patients who are known to avoid ingesting pills, i.e. medicaments and drugs. Even under careful supervision, a patient can deceive a caretaker and avoid taking necessary, often life-preserving, drugs.

Pub. No. US 2006/0289640 A1 to Mercure, et al., the contents of which is incorporated herein by reference, describes a conventional system in which an RFID electromagnetic tag is positioned in a capsule designed to disperse in the gastrointestinal system. Mercure, et al. relies on a breakdown of the pill in the gastrointestinal system to signal ingestion of the pill. However, the system of Mercure, et al. fails to overcome a significant shortcoming of RFID technology, particularly when a passive RFID chip is used. That is, the high fluid composition of the gastrointestinal system will adversely attenuate the RFID signal, creating a failure to detect ingestion and possibly resulting in undesirable overmedication. There are three possibilities for design of the wireless link. Radiation at high frequencies (UHF) is used for long-range communications in open air, but as the radiation is significantly attenuated by the body, it prohibits this type of wireless link. Inductive coupling at HF (1 MHz-30 MHz), used for power coupling of implantable devices, works only for very short distances, up to 10 cm, depending on the size of the coils and their orientation. Near-field UHF provides inherently stronger inductive coupling, and although the attenuation by the body at this frequency range is higher, it provides longer range of detection, up to 1 meter, which is almost on the order of the required distance.

A challenge of the design of such a wireless link is the extension of distance that can be achieved through near-field UHF, since due to weak coupling between antennas only a small part of emitted power by an external transmitter antenna reaches the RFID tag antenna. The present invention provides a modified design of an external reader to provide an elongated read range, via a spatially selective external reader, adopting beamforming concepts of antenna design, based on a gradient flow method, such those as described by M. Stanacevic and G. Cauwenberghs, “Micropower Gradient Flow VLSI Acoustic Localizer,” IEEE Trans. on Circuits and Systems I: Regular Papers, vol. 52(10), pp. 2148-2157, 2005; and by T. Nara.

The present invention overcomes the shortcomings of conventional systems by providing a focused ingestion monitoring device by use of electromagnetic tag technology RFID tags to ensure and track proper ingestion of oral medication, which is particularly relevant in hospital and long term care environments. The present invention provides a wireless system for monitoring ingestion of medicine and absorption into the body to insure proper dosage control and usage. To enable pill monitoring, an RFID tag is inserted in or affixed to the pill, and a wireless link between the RFID tag and an external reader is provided that will function when the pill is inside the body.

### SUMMARY OF THE INVENTION

Preferred embodiments of the present invention overcome the above shortcomings of conventional systems and methods by providing an apparatus for monitoring drug regimen compliance that includes a wearable RFID reader for detecting a Radio Frequency Identification (RFID) tag affixed to an pharmaceutical agent, and for wirelessly communicating with a central monitoring system upon detection of ingestion. The communication includes an identification of the ingested pharmaceutical agent. A database is updated to confirm drug regimen compliance by one or a plurality of patients, in an Internet based tracking system.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 is a perspective view of a wearable RFID reader worn around the neck of a patient in accordance with a preferred embodiment of the present invention.

### DETAILED DESCRIPTION OF THE PREFERRED EMBODIMENTS

The following detailed description of preferred embodiments of the invention will be made in reference to the accompanying drawings. In describing the invention, explanation about related functions or constructions known in the art are omitted for the sake of clearness in understanding the concept of the invention, to avoid obscuring the invention with unnecessary detail.

In the present invention, an electromagnetic RFID tag is provided on a pill, with the RFID tag providing information about the medicament when polled by the RFID reader. Antennas in the RFID tag and reader could be in different sizes and shapes, with the size of the tag antenna corresponding to the size of the pill, and the external reader fashioned in a manner to accommodate wearing by the patient on his or her body.

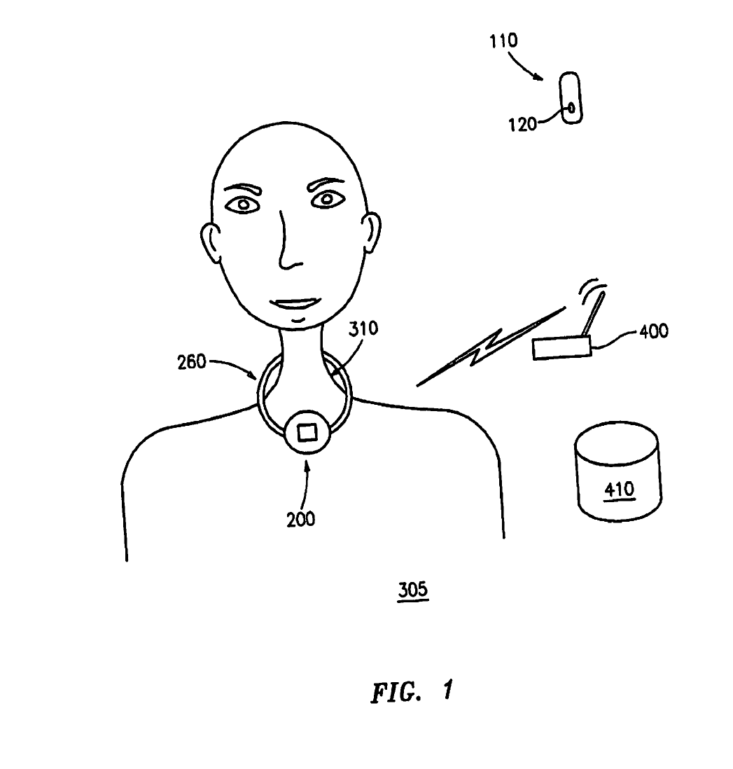

In a preferred embodiment, a necklace/pendant is provided for the reader, as shown in FIG. 1. In alternative embodiments, the reader is clipped to the belt or a waistband. With such configuration a maximum achievable distance at which the reader can detect the presence of the RFID tag extends beyond the distance between the RFID tag inside the body and the external reader.

In the present invention, spatial selectivity is possible as the region of the possible location of RFID tag is known, such as in regard to RFID tag localization, where measurements of the first-order spatial gradients of the magnetic field have been demonstrated. See, T. Nara and S. Ando, “Localization of RFID Tags from Measurement of Complex Gradients of Electromagnetic Fields”, International Workshop on Networked Sensing Systems (INSS 2004), pp. 63-66, 2004. The differential signal was produced by oppositely wound coils. Standard beamforming phased arrays techniques are not suitable for use in the external reader. The reason is that the performance of beamforming algorithms directly depends on the aperture of the array, and with the decreasing distance between array elements performance degrades, leading to the requirement of a large form factor of the external reader for extended range. A gradient flow method originates from localization of traveling waves. Location of the source can be obtained as an estimation of the source direction through computation of the spatial gradients for the arrays with dimensions smaller than but comparable to the wavelength. In spatial gradient representation, time delays are converted into relative amplitudes of the time-differentiated source signals, if the dimensions of the array are within certain bounds. By computing the spatial gradients, the problem of estimating unknown time delays becomes a computationally less expensive problem of estimation of amplitude modulation, solved in standard least-square fashion. Instead of localization, the gradient flow technique in the proposed spatially selective external reader is used to direct the magnetic energy into certain regions by generating spatial gradients using closely spaced antennas.

The present invention monitors drug regimen compliance by tracking an RFID tag (120) affixed to a pill (110), i.e. ingestible pharmaceutical agent, via a wearable RFID reader (200), preferably configured as a harness (260) worn by a patient (305), as shown in FIG. 1. The RFID tag (120) includes information identifying the pharmaceutical agent (110) and such information is wirelessly transmitted to reader (200), which in turn provides the information, along with an identification of the patient wearing the reader (200), to an Internet based central monitoring system (400), preferably immediately upon ingestion of the pharmaceutical agent (110).

The central monitoring system (400) will, upon communication and confirmation of the ingestion, compare the received information to information stored in a database (410) to determine whether the patient is sufficiently compliant with a prescribed drug regimen. Preferably, the database (410) will identify each of a plurality of harnesses respectively worn by a plurality of patients. Moreover, if a patient ingests an RFID labeled pill that is not prescribed for that patient, or if the patient ingests an excessive number of RFID labeled pills, the central monitoring system (400) will provide an overdose alarm to a caregiver.

In a preferred embodiment, an alarm is provided to a caregiver when the database is not updated at a predetermined interval, and the alarm will identify each particular patient who is not in compliance with that patient's prescribed drug regimen. The caretaker will also have access to a report generated at regular intervals showing times that ingestion is detected for each patient among the plurality of patients.

In a preferred embodiment, a plurality of antenna layers is provided on the RFID tag (120), with the layers separated by a plurality of coatings that sequentially dissolve during digestion. Preferably the RFID reader (200) detects whether a first layer of the RFID tag (120) has dissolved, which typically occurs upon exposure to liquid when placed in the patient's mouth. For purposes of fraud detection and to confirm proper ingestion, an alert is preferably provided if the first layer is detected as not being dissolved at the time of detection by the RFID reader (200), via an auxiliary antenna having a denser coating that dissolves further along the gastrointestinal tract.

In a preferred embodiment of the present invention, the harness (260) positions the RFID reader (200) adjacent to the patient's throat (310), and the RFID reader (200) is fixably secured to the harness (260). Further, it is preferred that the harness (260) wirelessly communicates an alarm when unfastened from the neck of the patient (305).

As an alternative to fixable securing harness (260), a second RFID tag can be incorporated into the wrist bracket that most hospitals provide upon admission, with the second RFID tag identifying the patient. Such wrist brackets are unique and can not be effectively removed without destroying the bracelet. Reader (200) would also poll the second RFID tag, and communicate the wrist mounted second RFID along with the identification of the ingested pill.

The RFID reader is preferably uni-directional, directed toward the patient's throat, to avoid a “false positive” that can arise if the patient dips the pill in water and then waives the pill near the reader, without ingesting, i.e. swallowing, the pill.

While the invention has been shown and described with reference to certain exemplary embodiments of the present invention thereof, it will be understood by those skilled in the art that various changes in form and details may be made therein without departing from the spirit and scope of the present invention as defined by the appended claims and equivalents thereof.

1-18. (canceled)

19. A system for monitoring drug regimen compliance, the system comprising:
a Radio Frequency Identification (RFID) tag affixed to and identifying a pharmaceutical agent; and
a wearable RFID reader that identifies a patient,
wherein the RFID reader wirelessly communicates with a central monitoring system upon ingestion by the patient of the pharmaceutical agent.

20. The system of claim 19, further comprising a database updated by the central monitoring system upon communication of ingestion.

21. The system of claim 19, further comprising a harness worn by a patient.

22. The system of claim 21, wherein the harness positions the RFID reader adjacent to the patient's throat.

23. The system of claim 21, wherein the RFID reader is fixably secured to the harness.

24. The system of claim 23, wherein the harness wirelessly communicates an alarm when unfastened.

25. The system of claim 20, wherein an identification of each of a plurality of harnesses respectively worn by a plurality of patients is wirelessly communicated.

26. The system of claim 19, wherein, upon detection of ingestion of the pharmaceutical agent, the database is updated to indicate drug regimen compliance by the patient.

27. The system of claim 26, wherein an alarm is provided to a caregiver when the database is not updated at a predetermined interval.

28. The system of claim 27, wherein the alarm identifies a patient not in compliance with the prescribed drug regimen.

29. The system of claim 25, wherein a report is generated at regular intervals showing ingestion detection times for each patient among the plurality of patients.

30. The system of claim 29, wherein the database includes historical trends for each of the plurality of patients and the report shows deviations from the historical trends.

31. The system of claim 19, wherein the RFID tag is encapsulated with biocompatible material insoluble in a patient gastrointestinal tract, with a polymer deposited on the capsule.

32. The system of claim 31, wherein only an antenna of the RFID tag is exposed in the gastrointestinal tract.

33. The system of claim 31, wherein the polymer becomes conductive upon detection of a pH value exceeding a predetermined threshold.

34. The system of claim 31, wherein the polymer becomes conductive upon ingestion, the wearable RFID reader establishes a wireless link between the RFID reader and the RFID tag based on inductive coupling between an antenna of the RFID reader and an antenna of the RFID tag identifying the RFID tag.

35. The system of claim 19, wherein the patient is identified by RFID polling of a second RFID tag affixed to a bracelet worn by the patient.

36. A portable monitor comprising a wearable Radio Frequency Identification (RFID) reader for wirelessly communicating with a remote monitoring system upon detection of ingestion of a pharmaceutical agent having an RFID tag affixed thereto.

37. The portable monitor of claim 36, wherein the RFID reader is affixed to a harness worn by a patient.

38. The portable monitor of claim 37, wherein the harness positions the RFID reader adjacent to the patient's throat and an alarm is wirelessly communicated when the harness is unfastened.
